(19) United States
(12) Patent Application Publication
(10) Pub. No.: US 2012/0258829 A1
(43) Pub. Date: Oct. 11, 2012

(54) POLYBUTADIENE-BASED POWER TRANSMISSION BELTING

(75) Inventors: Kent H. Little, Ozark, MO (US); Daniel Virtue, Rogersville, MO (US)

(73) Assignee: CARLISLE INTANGIBLE COMPANY, Syracuse, NY (US)

(21) Appl. No.: 13/081,959

(22) Filed: Apr. 7, 2011

(51) Int. Cl. F16G 1/10; F16G 1/06; C08L 9/06; C08L 7/00; C08L 9/00; C08K 3/04

(52) U.S. Cl. 474/266; 525/237; 524/526; 474/237

(57) ABSTRACT

A power transmission belt is provided with a peroxide-cured, polybutadiene-based elastomeric composition. The elastomeric composition includes 100 parts of a rubber derived from 50 to 100 parts by weight of polybutadiene rubber; 0 to 50 parts by weight of at least one other rubber; about 1 to about 20 parts by weight per 100 parts by weight of total rubber (phr) of a type I coagent; about 1 to about 20 phr of a type II coagent; and about 0.1 to about 10 phr of a peroxide curing agent.

### FIELD OF THE INVENTION

This invention relates to belting, more particularly to power transmission belting and methods of making the same.

### BACKGROUND OF THE INVENTION

Typical power transmission belts are composite structures made up of a compression section, a tension section, and a tensile section disposed between the compression and tension sections. The compression section, which contacts the sheave or pulley, is generally made up of a flexible, elastomeric composition that requires high abrasion and wear resistance. The tension section, which maintains the circumferential dimensions of the belt, may also include an elastomeric composition. Generally, fabric is also used in the tension section of the belt. The elastomeric composition used in the tension section requires sufficient flexibility and resistance to fatigue, as this section is subjected to repeated tension and elongation as the belt is carried over pulleys. The tensile or load-carrying section is generally made up of longitudinally extending, highly resilient, tensile strength members typically formed of a plurality of cords. These tensile strength members are generally embedded in or surrounded by a specially-adapted adhesive and/or elastomeric composition layer to maintain the physical integrity of the section. The varied functions of these different power transmission belt sections generally dictate that each is made of a distinct composition.

Power transmission is effected by making use of frictional forces generated between contacting surfaces of the compression section of the belt and a corresponding pulley. The frictional interface between the belt and the pulley induces heating and wearing down of the belt and thereby eventually leads to a shortened belt life due to mechanical failure. For example, in the aforementioned wear mechanism, worn rubber material, or “pills”, from the belt—pulley interface may deposit and re-harden in the grooves between the ribs of a ribbed V-belt. Over time, the belt “rides up” in the pulley due to these deposits, and thus the belt ultimately fails. Thus, excessive pilling eventually disrupts belt performance and can dramatically shorten a belt's lifetime. One attempt to counter pilling includes covering the sheave portion with a fabric material, but this further complicates the belt building process. Therefore, a need exists for simplified power transmission belts having improved resistance to abrasion and wear, as well as improved adhesive properties and flex resistance to achieve longer belt lifetimes.

### SUMMARY OF THE INVENTION

This invention relates to elastomeric compositions, and power transmission belting made therefrom. According to embodiments of the present invention, polybutadiene rubber is the primary rubber, which when peroxide-cured in the presence of coagents and fillers provides a material suitable for power transmission belts having improved resistance to pilling and an extended belt lifetime. As used herein, “primary rubber” means that 50 weight percent or more of the rubber that make up the elastomeric composition is polybutadiene.

According to one embodiment of the present invention, a power transmission belt is provided that includes a first elastomeric composition derived from an uncured elastomeric composition including 100 parts of a rubber derived from 50 to 100 parts by weight of polybutadiene rubber, 0 to 50 parts by weight of at least one other rubber; about 1 to about 20 parts by weight per 100 parts by weight of total rubber (phr) of a type I coagent; about 1 to about 20 phr of a type II coagent; and about 0.1 to about 10 phr of a peroxide curing agent.

According to another embodiment of the present invention, a two-component power transmission belt is provided that includes a plurality of longitudinally extending tensile strength members embedded in an elastomeric composition that is derived from an uncured elastomeric composition including 100 parts of a rubber derived from 50 to 100 parts by weight of polybutadiene rubber, 0 to 50 parts by weight of at least one other rubber; about 1 to about 20 parts by weight per 100 parts by weight of total rubber (phr) of a type I coagent; about 1 to about 20 phr of a type II coagent; and about 0.1 to about 10 phr of a peroxide curing agent.

According to yet another embodiment of the present invention, an elastomeric composition is provided that includes 100 parts of a rubber derived from 50 to 100 parts by weight of polybutadiene rubber, 0 to 50 parts by weight of at least one other rubber; about 1 to about 20 parts by weight per 100 parts by weight of total rubber (phr) of a type I coagent; about 1 to about 20 phr of a type II coagent; and about 0.1 to about 10 phr of a peroxide curing agent.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to describe the invention.

FIG. 1 is a perspective view, with parts in section, of a portion of a power transmission belt constructed in accordance with an embodiment of the present invention;

FIG. 2 is a perspective view, with parts in section, of a portion of a power transmission belt constructed in accordance with another embodiment of the present invention; and

FIG. 3 is a perspective view, with parts in section, of a portion of a power transmission belt constructed in accordance with yet another embodiment of the present invention.

### DETAILED DESCRIPTION OF SPECIFIC EMBODIMENTS

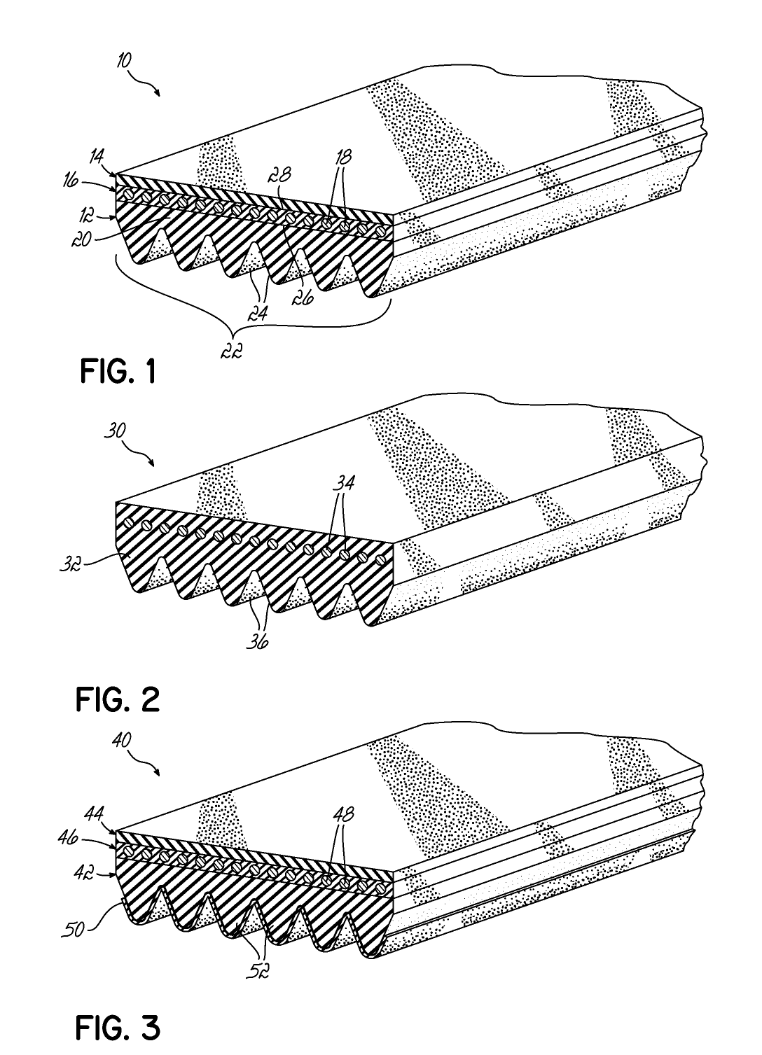

FIG. 1 shows a perspective view of a cut-away showing sections of a power transmission belt 10 according to an embodiment of the present invention. The power transmission belt has a compression section 12, a tension section 14, and a tensile section 16 having a plurality of longitudinally extending tensile strength members 18 embedded therein. The compression section 12 includes a body portion 20 and a sheave portion 22, which has a plurality of, (in this case six,) V-shaped ribs 24 formed therein. The tensile section 16 has two opposing surfaces 26, 28 to which the compression section 12 and the tension section 14 are attached.

According to embodiments of the present invention, an elastomeric composition is provided that demonstrates desirable properties that permit the inclusion of the elastomeric composition in the compression section 12, the tension section 14, the tensile section 16, or combinations thereof.

According to one embodiment of the present invention, an elastomeric composition is provided that includes 100 parts of a rubber derived from 50 to 100 parts by weight of polybutadiene rubber, 0 to 50 parts by weight of at least one other rubber; about 1 to about 20 parts by weight per 100 parts by weight of total rubber (phr) of a type I coagent; about 1 to about 20 phr of a type II coagent; and about 0.1 to about 10 phr of a peroxide curing agent.

Accordingly, the elastomeric compositions are peroxide-cured, polybutadiene-based elastomeric compositions wherein polybutadiene (PBD) is the primary rubber. The elastomeric compositions may further include additional rubbers. According to one embodiment, the additional rubbers are selected from the group consisting of natural rubber (NR) and styrene butadiene rubber (SBD). According to another embodiment, the elastomeric composition is substantially free of ethylene-alpha-olefin elastomers. As used herein, “substantially free” means that ethylene-alpha-olefin elastomers are not intentionally added to the elastomeric compositions.

Polybutadiene is generally available with various isomeric ratios of 1,4-cis (“cis”), 1,4-trans (“trans”), and 1,2-vinyl (“vinyl”) isomers. However, according to embodiments of the present invention, the polybutadiene has a high cis content, such as those obtainable by polymerization of butadiene with a cobalt catalyst or a neodymium catalyst. As used herein, “high cis” PBD is understood to comprise greater than 60% of the cis isomer. Exemplary commercially-available “high cis” PBDs include Taktene 1203-G1 and Taktene 220 (LANXESS Deutschland GmbH; Orange, Tex.), as well as BUNA CB 24 (LANXESS Deutschland GmbH; Port Jerome, FR). The elastomeric compositions of the present invention include at least 50 parts of high cis PBD rubber, such as 60 parts, 70 parts, 80 parts, 90 parts, 95 parts or 100 parts.

When the PBD rubber is less than the entire 100 parts, the remaining balance of rubber may be made up from one or more additional rubbers. According to one embodiment, the remaining balance of rubber is made up of NR, SBR or combinations thereof. The natural rubber may include polyisoprene derived from various sources, such as a SIR 3CV60 grade natural rubber. SBR is a copolymer of styrene and butadiene which may be polymerized in various ratios. One exemplary SBR is SBR-1500 (Lion Copolymer, LLC., Baton Rouge, La.). SBR-1500 is a high molecular weight rubber that has relatively wide molecular weight distribution and the butadiene component has an average of about 9% cis, about 54.5% trans and about 13% vinyl structure. The elastomeric compositions of the present invention include less than 50 parts of NR, SBR or combinations thereof. For example, NR may be present in an amount ranging from about 0 parts to about 50 parts, about 0 parts to about 25 parts, or about 2 parts to about 20 parts; and SBR may be present in an amount ranging from about 0 parts to about 50 parts, about 5 parts to about 40 parts, or about 10 parts to about 30 parts.

In one or more embodiments, the PBD, NR, and SBR polymers have a weight average molecular weight (Mw) that is greater than 50,000, in other embodiments a Mw greater than 100,000, in other embodiments a Mw greater than 200,000, and in yet other embodiments a Mw greater than 300,000; and the weight average molecular weight of the polymers is less than 1,200,000, in other embodiments less than 1,000,000, in other embodiments less than 900,000, and in other embodiments less than 800,000. In one or more embodiments, the PBD, NR, and SBR polymers have a number average molecular weight (Mn) that is greater than 20,000, in other embodiments a Mn greater than 60,000, in other embodiments a Mn greater than 100,000, and in other embodiments a Mn greater than 150,000; and the number average molecular weight of the polymers is less than 500,000, in other embodiments less than 400,000, in other embodiments less than 300,000, and in other embodiments less than 250,000.

By compounding the PBD, NR and SBR with cross-linking coagents, the degree of cross-linking within the elastomeric composition can be increased, thereby modifying the physical and dynamic properties of the peroxide-cured elastomeric composition. Type I and Type II coagents are classified based on their contributions to the curing process. Type I coagents generally increase both the rate and state of cure. Type I coagents are typically polar, multifunctional low molecular weight compounds which form very reactive radicals through addition reactions. These monomers can be homopolymerized or grafted to polymer chains. Type I coagents may include, but are not limited to, multifunctional acrylate and methacrylate esters, arylene dimaleimides, and metal salts of an α,β-unsaturated organic acid and may be present in an amount ranging from about 1 phr to about 20 phr, for example, from about 2 to about 20 phr, from about 5 phr to about 15 phr, or from about 8 phr to about 15 phr.

Examples of multi-functional acrylates suitable as Type I coagents include ethylene glycol diacrylate (EGDA), trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates suitable as Type I coagents include trimethylol propane trimethacrylate (TMPTMA), ethylene glycol dimethacrylate (EGDMA), butanediol dimethacrylate, butylene glycol dimethacrylate, diethylene glycol dimethacrylate, polyethylene glycol dimethacrylate, allyl methacrylate, or combinations thereof. One commercial source of TMPTMA is Flowsperse PLB-5405 75% TMPTMA (Flow Polymers, Inc. Cleveland, Ohio).

Exemplary arylene dimaleimides include N,N′-m-phenylene dimaleimide (PDM).

Exemplary metal salts of acrylates and methacrylates include salts wherein the metal is selected from the group consisting of zinc, cadmium, calcium, magnesium, sodium and aluminum salts, and wherein the α,β-unsaturated organic acid is chosen from the group consisting of acrylic, methacrylic, maleic, fumaric, ethacrylic, vinyl-acrylic, itaconic, methyl itaconic, aconitic, methyl aconitic, crotonic, alpha-methylcrotonic, cinnamic, and 2,4-dihydroxy cinnamic acids. Exemplary Type I metal salts include zinc diacrylate (ZDA), such as SR633 (Cray Valley SA) and zinc dimethacrylate (ZDMA), such as SR634 (Cray Valley SA).

Type II coagents generally form less reactive radicals and are thought to only contribute to the state of cure. Type II coagents include allyl-containing cyanurates, isocyanurates, and phthalates, high vinyl homopolymers of dienes, high vinyl copolymers of dienes and vinyl aromatics, and maleinized homopolymers of dienes, and are usually present in the elastomeric composition in an amount ranging from about 1 phr to about 20 phr. For example, from about 2 to about 18 phr, from about 3 phr to about 15 phr, or from about 4 phr to about 10 phr.

Exemplary Type II coagents include, but are not limited to, triallyl cyanurate, triallyl isocyanurate, high vinyl polybutadiene, maleinized liquid polybutadiene, and high vinyl styrene butadiene. One example of a high vinyl polybutadiene is Ricon® 154D (Cray Valley SA), which is provided as a dispersed mixture on synthetic calcium silicate of about 65% by weight PBD having about 90% vinyl structure. One example of a maleinized liquid polybutadiene is Ricobond® 1756HS, which is provided as a dispersed mixture on hydrated amorphous silica of about 70% by weight of a low molecular weight polybutadiene functionalized with maleic anhydride.

Peroxide curing agents are used to facilitate the cross-linking of the rubbers and coagents. Exemplary peroxide curing agents include organic peroxides, such as dicumyl peroxide, di-t-butyl peroxide, t-butylcumyl peroxide, dibenzoyl peroxide, 1,3-bis(t-butylperoxyisopropyl)benzene, 1,4-bis(t-butylperoxyisopropyl)benzene, 2,5-dimethyl-2,5-di(t-butylperoxy)hexyne-3,2,5-dimethyl-2,5-(benzoylperoxy)hexane, and 2,5-dimethyl-2,5-mono(t-butyl-peroxy)hexane. Examples of commercially-available organic peroxides include Di-Cup® 40KE, Geo Specialty Chemicals; Akrochem® VC-40K, Akrochem Corporation; and Varox® DBPH 50, R.T. Vanderbilt Company, Inc. The peroxide curing agents are present in the elastomeric composition in an amount ranging from about 0.1 phr to about 10 phr, for example, from about 0.1 phr to about 8 phr, from about 0.4 phr to about 6 phr, or from about 0.8 phr to about 4 phr.

Reinforcing fillers, such as carbon black and silica, may also be included in the elastomeric composition. Commonly employed carbon blacks can be used as a filler. For example, tread-type carbon blacks are suitable for use in the elastomeric compositions. Representative examples of carbon blacks include N220, N234, N326, N330, N339, N347, N550, and N650. Various commercially-available silicas may be used, for example silicas available from PPG Industries under the Hi-Sil™ trademark with designations 210, 243, etc; silicas available from Rhone-Poulenc, with, for example, designations of Z1165 MP™ and Z165GR™; and silicas available from Degussa AG with, for example, designations VN2™ and VN3™. The silica filler may also be hydrate and/or treated with a coupling agent, such as gamma aminopropyl triethoxysilane or γ-methacryloxypropyl trimethoxysilane. The reinforcing filler may be incorporated into the elastomeric composition in an amount ranging from about 25 to about 250 phr. For example, in one embodiment, the reinforcing filler is carbon black and is present in an amount ranging from about 30 to about 150 phr. In another example, carbon black is present in an amount ranging from about 40 to about 100 phr.

Other conventional additives can also be included. For example, other conventional fillers such as calcium carbonate and talc, plasticizers such as aromatic extract oils, antioxidants such as zinc 2-mercaptotouidmidazole (ZMTI) and polymerized 2,2,4-trimethyl-1,2-dihydroquinoline (TMQ), processing aids such as zinc oxide, zinc stearate, and stearamides such as TR141 OC (available from Struktol Company of America Stow, Ohio), and coloring agents, can be used in the elastomeric compositions.

Further, fibers may be mixed into the elastomeric compositions. The fibers may be made from materials such as cotton, rayon, polyester, aramid, nylon, fiberglass, carbon, polyimide, metals, alloys or combinations thereof. These fibers may increase abrasion resistance and improve lateral pressure resistance when the fiber-reinforced composition is used in the compression section 12. When present, the fibers may have a length from about 0.1 to about 20 mm and may be present in an amount from 0.1 to 30 phr, for example. One exemplary fiber is Akroflock™ CDV2, which is a dark cotton fiber commercially-available from Akrochem Corporation (Akron, Ohio).

In the elastomeric compositions reinforced with fibers, the interface between the fibers and PBD, NR, SBR and coagents may be grafted using an adhesive, such as a resorcinol-formaldehyde-latex (RFL) dip or a novolak-type phenol resin, or using a coupling agent, such as a silane coupling agent, a titanate-based coupling agent, or an unsaturated carboxylic acid, for example. Exemplary silane coupling agents include, for example, vinyl tris(β-methoxyethoxy)silane, vinyl triethyoxysilane, and γ-methacryloxypropyl trimethoxysilane. Exemplary titanate-based coupling agents include, for example, isopropyl triisostearoyl titanate. Exemplary unsaturated carboxylic acids include acrylic acid, methacrylic acid, and maleic acid.

In the elastomeric compositions reinforced with fibers, the fibers are chemically bonded to or are interactive with the rubber component at an interface between the two. Thus, an elastomeric composition containing fiber-reinforced rubber resists cracking and crack propagation. The elastomeric compositions reinforced with fibers may be used in the compression section, the tensile section, the tension section, or combinations thereof. A power transmission belt using this elastomeric composition demonstrates improved temperature resistance, flex resistance, and abrasion resistance.

The tensile strength members 18 in the tensile section 16 may be made of materials, such as cotton, rayon, polyester, aramid, nylon, fiberglass, carbon, polyimide, metals, alloys or combinations thereof. The tensile strength members 18 may be in the form of cords, braids, wires, or oriented discontinuous fibers.

The tensile strength members 18 may be exposed to an adhesion treatment to improve the adhesion with the elastomeric composition in the tensile section 16. The interface between the tensile strength members 18 and the PBD, NR, SBR and coagents may be grafted using an adhesive, such as a resorcinol-formaldehyde-latex (RFL) dip or a novolak-type phenol resin, or the fibers may be grafted using a coupling agent, such as a silane coupling agent, a titanate-based coupling agent, or an unsaturated carboxylic acid, for example. In one form of adhesion treatment, the tensile strength members 18 are immersed in RFL liquid and dried by heating to form a uniform adhesive layer on the surfaces thereof. It is also possible to pre-treat the tensile strength members 18 with an epoxy compound or isocyanate compound and thereafter to treat the fibers with the RFL liquid.

An exemplary adhesive includes Chemlok® 6100, which is commercially available from the Lord Corporation of Cary, N.C. Chemlok® 6100 may be used in combination with a primer coating of Chemlok® 205 or 207 primer. This adhesive system is suitable to bond elastomeric compositions based on polybutadiene, natural rubber, and styrene-butadiene to metal.

Exemplary tensile strength members include aramid fibers coated with an RFL adhesive, polyester fiber coated with Chemlok® 6100, glass fibers coated with Chemlok® 6100, and combinations thereof.

The tension section may include one or more layers of a fibrous or fabric material backing on an outer circumference of the power transmission belting. As described above, the interface between the fibrous or the fabric material backing and the peroxide-cured elastomeric composition may be grafted using an adhesive.

The mixing of the elastomeric composition can be accomplished by methods known to those having skill in the rubber mixing art. For example, the ingredients are typically mixed in at least two stages, namely, at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) of the preceding non-productive mix stage(s). The rubber and fillers such as carbon black and optional silica and coupler, and/or non-carbon black and non-silica fillers, are mixed in one or more non-productive mix stages. The terms “non-productive” and “productive” mix stages are well known to those having skill in the rubber mixing art.

According to one embodiment, an uncured elastomeric composition is prepared using a multi-step process. In a first step, a non-productive mixing step, all of the rubbers, processing aids, Type II coagents, fibers, and filler(s), are combined in a Banbury mixer and mixed at temperature in a range from about 200° F. to about 300° F. for a period of time ranging from about 1 minute to about 10 minutes. In a productive mixing step, the Type I coagents and the peroxide curing agent are added to the mixed components from the non-productive mixing step and mixed at a temperature in a range from about 180° F. to about 240° F. for a period of time ranging from about 1 min to about 10 min to form the uncured elastomeric composition. The uncured elastomeric composition is then transferred to equipment for sheeting out to a nominal size, such as one inch, for easier handling. The sheeted out, uncured elastomeric composition may then be transferred to equipment for calendaring out to a specific target thickness. Because the uncured elastomeric compositions demonstrate acceptable levels of tack, the calendared material may be stored on rolls in combination with a liner.

After building a belt with the uncured elastomeric composition, the belt is heated to a curing temperature to induce the formation of free radicals by the thermal decomposition of the peroxide curing agent. For example, the belt may be heated with steam to a temperature in a range from about 320° F. to about 385° F. for a sufficient time to affect curing. If desired, the compression section may be formed (e.g., with teeth) prior to curing. Alternatively, the belt may be ground after curing to provide teeth or ribs.

According to the embodiment shown in FIG. 1, the elastomeric composition may be utilized in the compression section 12, the tension section 14, and/or the tensile section 16 of the power transmission belt 10. According to another embodiment, as shown in FIG. 2, a simplified power transmission belt 30 is provided that employs a unitary body section 32 of a peroxide-cured, polybutadiene-based elastomeric composition for the compression section, the tension section and the tensile section, and the tensile strength members 34 are embedded therein. This simplified power transmission belt is only possible because of the extremely favorable combination of properties possessed by the elastomeric compositions of the present invention. These properties include improved resistance to abrasion and wear, as well as improved adhesive properties and flex resistance, all of which contribute to achieving longer belt lifetimes.

Further, as the elastomeric compositions of the present invention possess favorable resistance to pilling, the elastomeric compositions are especially well-suited for use in a portion of the belt that contacts the pulley or the sheave. For example, the entire compression section 12 of belt 10 shown in FIG. 1 may be made from the elastomeric compositions of the present invention. Alternatively, as shown in FIG. 3, a power transmission belt 40 may be provided having a compression section 42, a tension section 44 and a tensile section 46 with longitudinally extending tensile strength members 48. According to this embodiment, the belt 40 may further include a protective layer 50 of the elastomeric composition that conforms to a plurality of teeth 52 in the compression section 42. This protective layer 50 provides an enhanced resistance to pilling for the belt 40.

Additionally, as the elastomeric compositions possess favorable adhesion to materials used in forming the fibers and/or the tensile strength members, these elastomeric compositions are amenable for use in any section wherein fibers or tensile strength members are incorporated therein. For example, the tension section 44 and the tensile section 46 of the belt 40 shown in FIG. 3 may be prepared with the elastomeric compositions.

According to the embodiment shown in FIG. 2, production of the power transmission belt 30 may occur as follows. After initially winding one or more layers of calendared sheets of the elastomeric composition around a cylindrical molding drum, the tensile strength members 34 (e.g., aramid cords coated with an RFL adhesive) are spirally wound over the one or more layers of calendared sheets, after which additional layer(s) of calendared sheets of the elastomeric composition are applied. Cross-linking of the elastomeric composition to form a unitary body may be initiated by heating to a sufficient temperature to induce the formation of radicals from the decomposition of the peroxide curing agent to obtain a cross-linked sleeve.

The cross-linked sleeve is trained around driving and driven rolls and driven therearound at a predetermined tension and speed. A grinding wheel may be brought into contact with the moving, cross-linked sleeve to form grooves 36 simultaneously on the exposed surface of the unitary body 32.

The ground cross-linked sleeve may then be removed from the rolls and trained around separate driving and driven rolls, on which it is driven and cut to a desired width by a cutter to produce finished belts.

The invention can now be further described with respect to the following examples.

TABLE 1
Exemplary elastomeric compositions.

| | Ex. 1 | Ex. 2 | Ex. 3 | Ex. 4 | Ex. 5 | Ex. 6 |
|---|---|---|---|---|---|---|
| Non-productive | | | | | | |
| mixing steps | | | | | | |
| PBD A | 70 | 70 | 70 | 70 | 70 | 49 |
| PBD B | | | | | | 21 |
| NR | 10 | 10 | 20 | 10 | 10 | 10 |
| SBR | 20 | 20 | 10 | 20 | 20 | 20 |
| ZnO | 5 | 5 | 5 | 5 | 5 | 5 |
| Carbon Black | 50 | 50 | 48 | 56 | 52 | 52 |
| Fiber | | | 4 | | | |
| TMQ | 1 | 1 | 1 | 1 | 1 | 1 |
| ZTMI | 1 | 1 | 1 | 1 | 1 | 1 |
| Type II coagent | 4 | 4 | 10 | 4 | 6 | 8 |
| Zinc Stearate | 2 | 2 | 2 | 2 | 2 | 2 |
| strearamide | | | | | 2 | 1 |
| Productive | | | | | | |
| mixing step | | | | | | |
| Type I coagent | 1 | 4 | 8.4 | 6 | | 10 |
| A | | | | | | |
| Type I coagent | 6 | 6 | | 4 | | |
| B | | | | | | |
| Curing Agent | 1.25 | 1.25 | | 1.25 | 1.25 | 1.4 |
| | 171.25 | 174.25 | 180.65 | 180.25 | 180.25 | 181.4 |

TABLE 2
Testing results of elastomeric compositions.

| | Ex. 1 | Ex. 2 | Ex. 3 | Ex. 4 | Ex. 5 | Ex. 6 |
|---|---|---|---|---|---|---|
| 350 Rheo, | 2.76 | 2.74 | 2.98 | 3.26 | 2.08 | 2.58 |
| ML (N-m) | | | | | | |
| TS1 (min) | 0.55 | 0.55 | 0.68 | 0.68 | 0.73 | 0.82 |
| TC50 (min) | 2.22 | 2.30 | 2.48 | 2.47 | 2.53 | 2.83 |
| TC90 (min) | 6.85 | 6.85 | 6.8 | 6.8 | 7.17 | 7.83 |
| MH (N-m) | 35.89 | 33.07 | 27.06 | 27.82 | 27.76 | 25.9 |
| RT Dyn Loss | 7.04 | 8.25 | 9.14 | 9.58 | 7.72 | 10.16 |
| θ (deg) | | | | | | |
| Dyn Com Mod | 18.64 | 16.93 | 15.41 | 15.04 | 15.05 | 13.00 |
| E′ (MPa) | | | | | | |
| Tensile (MPa) | 12.96 | 15.45 | 14.82 | 16.40 | 18.00 | 17.07 |
| Elong (%) | 165 | 215 | 330 | 308 | 352 | 401 |
| Mod 10% | 1.30 | 1.28 | 1.25 | 1.28 | 1.18 | 1.03 |
| (MPa) | | | | | | |
| Mod 50% | 3.36 | 3.05 | 2.41 | 2.41 | 2.54 | 2.05 |
| (MPa) | | | | | | |
| Mod 100% | 6.74 | 6.20 | 3.78 | 4.18 | 4.30 | 3.28 |
| (MPa) | | | | | | |
| Shore A | 75 | 73 | 73 | 71 | 71 | 67 |
| DIN Abr | 77.9 | 77.7 | 78.4 | 78.1 | 71.1 | 66.3 |
| (mm³) | | | | | | |

Two-component belting was prepared according to the above described procedure using Chemlok® 6100 coated polyester/fiberglass cords and the elastomeric compositions of Table 1. The elastomeric compositions, as well as the cured belts, were subjected to standard testing; the testing data of the elastomeric compositions is shown in Table 2. Additionally, the cured belts were evaluated under a customized testing procedure that accelerates the wearing down of the belt to evaluate pilling resistance.

As discussed above, one of the failure modes common to power transmission belts, such as v-ribbed belts, is pilling. This failure mode occurs when wear particles, i.e., material which has worn from the surface of the belt contacting a pulley, begins to pile up in the valleys between the ribs of the belt as the belt is operated over a set of pulleys. Without being bound by any particular theory, the mechanism of pilling is believed to be derived from softening of the wear particles through reversion of the material via heat and shearing effects from the belt rubbing and sliding on the pulley or sheave groove sidewalls. The softened material adheres to itself and the belt. As such, the wear particles remain lodged between the ribs of the belt. In most cases the belt slips excessively and either slips out or operates erratically.

In order to replicate this failure mode in the laboratory, a pilling resistance test was developed that accelerates the amount of particulate expelled from the belt sidewalls and promotes pilling. The pilling resistance test uses a combination of a small diameter drive pulley coupled to a large diameter driven pulley. The smaller diameter driver pulley is rotated at a specified RPM. Further, a specified RPM pulse is applied to the base RPM of the small driver pulley. A specified torque is applied to the larger driven pulley in order to induce greater amount of slip on the smaller driver pulley. The smaller diameter pulley having less contact area on the belt, is forced to slip. In addition, RPM pulses, which further accelerate wear and heat generation, are applied as the driver pulley is sped up and slowed down rapidly. Lastly, wear on the belt is further accelerated through the use of a rough surface finish on the pulley. The rough surface finish is created by machining the small pulley from a porous metal casting. The roughened pulley surface creates additional wear particles through increased abrasion of the belt sidewalls.

The specific testing parameters were as follows: DriveR: 25 mm×J8 Porous Metal Pulley; DriveN: 3.35″×J8; DriveR RPM=3500; DriveN Torque=7.9 N-m; RPM Input Signal=square wave@ 5 Hz; Belt Size: 190J4 up through 230J4; Output Signal from Driver: monitored by oscilloscope (˜70 RPM fluctuation range); Tension: 80 lbs constant hub load; and Duration: 120 hours. Evaluation of belts constructed from the inventive compounds generate much less pilling/balling than those utilizing a more conventional sulfur cure system with the same or similar ratios of polymers and fillers. Qualitatively, the wear particles of the inventive compositions remained as substantially unassociated particles and resist the formation of pills. This finding provides a very robust compound composition which can be employed in very adverse operating conditions without pilling/balling.

As used herein and in the appended claims, the singular forms “a”, “an”, and the include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

While the present invention has been illustrated by the description of one or more embodiments thereof, and while the embodiments have been described in considerable detail, this description of the embodiments is not intended to restrict or in any way limit the scope of the appended claims to such detail. Additional advantages and modifications will readily appear to those skilled in the art. The invention in its broader aspects is therefore not limited to the specific details, representative product and/or method and examples shown and described. The various features of exemplary embodiments described herein may be used in any combination. Accordingly, departures may be made from such details without departing from the scope of the general inventive concept.

What is claimed is:

1. A power transmission belt comprising a first elastomeric composition derived from an uncured elastomeric composition comprising:
100 parts of a rubber derived from
50 to 100 parts by weight of polybutadiene rubber, and
0 to 50 parts by weight of at least one other rubber;
about 1 to about 20 parts by weight per 100 parts by weight of total rubber (phr) of a type I coagent;
about 1 to about 20 phr of a type II coagent; and
about 0.1 to about 10 phr of a peroxide compound.

2. The power transmission belt of claim 1, further comprising:
a compression section having a body portion and a sheave portion;
a tensile section; and
a tension section,
wherein at least one of the compression section, the tensile section, or the tension section comprises the first elastomeric composition.

3. The power transmission belt of claim 2, wherein the tensile section includes a second elastomeric composition and at least one longitudinally extending tensile strength member, wherein the at least one longitudinally extending tensile strength member is embedded in the second elastomeric composition.

4. The power transmission belt of claim 1, wherein the at least one other rubber is selected from the group consisting of natural rubber and styrene butadiene rubber.

5. The power transmission belt of claim 1, wherein the body portion and the sheave portion comprises the first elastomeric composition.

6. The power transmission belt of claim 1, wherein the first elastomeric composition and the second elastomeric composition are substantially the same composition.

7. The power transmission belt of claim 1, wherein polybutadiene is present in an amount equal to or greater than 70 parts by weight.

8. The power transmission belt of claim 1, wherein the type I coagent is selected from the group consisting of multifunctional acrylate and methacrylate esters, phenylene dimaleimide, and metal salts of an α,β-unsaturated organic acid, wherein the metal is selected from the group consisting of zinc, cadmium, calcium, magnesium, sodium and aluminum salts, and wherein the α,β-unsaturated organic acid is chosen from the group consisting of acrylic, methacrylic, maleic, fumaric, ethacrylic, vinyl-acrylic, itaconic, methyl itaconic, aconitic, methyl aconitic, crotonic, alpha-methylcrotonic, cinnamic, and 2,4-dihydroxy cinnamic acids.

9. The power transmission belt of claim 1, wherein the type II coagent is selected from the group consisting of allyl-containing cyanurates, isocyanurates and phthalates, homopolymers of dienes, and copolymers of dienes and vinyl aromatics.

10. The power transmission belt of claim 1, wherein the type II coagent is a high vinyl polybutadiene.

11. The power transmission belt of claim 1, wherein the uncured elastomeric composition further comprises about 25 phr to about 250 phr of a filler selected from carbon black, calcium carbonate, talc, clay, or silica, or mixtures thereof.

12. The power transmission belt of claim 11, wherein the peroxide curing agent is selected from the group consisting of dicumyl peroxide, di-t-butyl peroxide, t-butylcumyl peroxide, dibenzoyl peroxide, 1,3-bis(t-butylperoxyisopropyl)benzene, 1,4-bis(t-butylperoxyisopropyl)benzene, 2,5-dimethyl-2,5-di(t-butylperoxy)hexyne-3,2,5-dimethyl-2,5-(benzoylperoxy)hexane, and 2,5-dimethyl-2,5-mono(t-butyl-peroxy)hexane.

13. The power transmission belt of claim 1, wherein the at least one longitudinally extending tensile strength member comprises cotton, rayon, polyester, aramid, nylon, or fiberglass, carbon, polyimide, or metallic fibers, or combinations thereof, and is formed into a braid, wire, or oriented discontinuous fibers.

14. A power transmission belt consisting essentially of:
a body section comprising an elastomeric composition derived from an uncured elastomeric composition including:
100 parts of a rubber derived from
50 to 100 parts by weight of polybutadiene rubber,
0 to 50 parts by weight of at least one of natural rubber and styrene butadiene rubber;
about 1 to about 20 parts by weight per 100 parts by weight of total rubber (phr) of a type I coagent;
about 1 to about 20 phr of a type II coagent; and
about 0.1 to about 10 phr of a peroxide compound; and
a plurality of longitudinally extending tensile strength members embedded in the body section.

15. An elastomeric composition comprising:
100 parts by weight of a rubber derived from
50 to 100 parts by weight of polybutadiene rubber,
0 to 50 parts by weight of at least one other rubber;
about 1 to about 20 parts by weight per 100 parts by weight of total rubber (phr) of a type I coagent;
about 1 to about 20 phr of a type II coagent; and
about 0.1 to about 10 phr of a peroxide curing agent.

16. The elastomeric composition of claim 15, wherein the at least one other rubber is selected from the group consisting of natural rubber and styrene butadiene rubber.

17. The elastomeric composition of claim 15, wherein polybutadiene rubber is present in an amount equal to or greater than 70 parts by weight.

18. The elastomeric composition of claim 15, wherein the type I coagent is selected from the group consisting of multifunctional acrylate and methacrylate esters, phenylene dimaleimide, and metal salts of an α,β-unsaturated organic acid, wherein the metal is selected from the group consisting of zinc, cadmium, calcium, magnesium, sodium and aluminum salts, and wherein the α,β-unsaturated organic acid is chosen from the group consisting of acrylic, methacrylic, maleic, fumaric, ethacrylic, vinyl-acrylic, itaconic, methyl itaconic, aconitic, methyl aconitic, crotonic, alpha-methylcrotonic, cinnamic, and 2,4-dihydroxy cinnamic acids.

19. The elastomeric composition of claim 15, wherein the type II coagent is selected from the group consisting of allyl-containing cyanurates, isocyanurates and phthalates, homopolymers of dienes, and copolymers of dienes and vinyl aromatics.

20. The elastomeric composition of claim 15, wherein the type II coagent is a high vinyl polybutadiene.

21. The elastomeric composition of claim 15 further comprising about 25 phr to about 250 phr of a filler selected from carbon black, calcium carbonate, talc, clay, silica, or mixtures thereof.

22. The elastomeric composition of claim 15, wherein the peroxide curing agent is selected from the group consisting of dicumyl peroxide, di-t-butyl peroxide, t-butylcumyl peroxide, dibenzoyl peroxide, 1,3-bis(t-butylperoxyisopropyl)benzene, 1,4-bis(t-butylperoxyisopropyl)benzene, 2,5-dimethyl-2,5-di(t-butylperoxy)hexyne-3,2,5-dimethyl-2,5-(benzoylperoxy)hexane, and 2,5-dimethyl-2,5-mono(t-butyl-peroxy)hexane.
